(19) United States
(12) Patent Application Publication
(10) Pub. No.: US 2007/0139215 A1
(43) Pub. Date: Jun. 21, 2007

(54) Remote control device and information reproducing system

(75) Inventors: Shojiro Sato, Kawasaki-shi (JP); Toshikazu Mochizuki, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/635,038

(22) Filed: Dec. 7, 2006

(30) Foreign Application Priority Data
Dec. 15, 2005 (JP) 2005-361960

(51) Int. Cl. G07C 9/00

(52) U.S. Cl. 340/825.72; 341/176; 340/825.56

(57) ABSTRACT

According to one embodiment, a remote control device of the present invention has an input section constituted of a plurality of button groups, a direction key, a determine button and the like, and has a function of a backlight to allow a main body to emit light for a first predetermined time from an operation time. Moreover, from a time when a cell is turned on until a first operation is performed by the input section, a microcomputer stops lighting of the backlight.

### CROSS-REFERENCE TO RELATED APPLICATIONS

This application is based upon and claims the benefit of priority from Japanese Patent Application No. 2005-361960, filed Dec. 15, 2005, the entire contents of which are incorporated herein by reference.

### BACKGROUND

1. Field

One embodiment of the invention relates to a remote control device and an information reproducing system, more particularly to a backlight display of a remote control device in a case where an operation is performed.

2. Description of the Related Art

Heretofore, a multifunctional remote control device has been put to practical use which is capable of operating a plurality of units such as a television and a VTR with one device. Moreover, to facilitate the operation in a dark room or the like, there is known a remote control device provided with a function of backlight display. Since the remote control device, in general, uses a dry cell as a power source, to prevent the dry cell from being worn-out, various measures are taken.

For example, in Jpn. Pat. Appln. KOKAI Publication No. 10-304480, a technology is disclosed in which a backlight is lit for a predetermined time from an operation time in response to a key operation performed by a user and reaction of a vibration sensor.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an appearance of a remote control device in a first embodiment of the present invention;

FIG. 2 is a block diagram showing a schematic constitution of a remote control device 10 of FIG. 1;

FIG. 3 is an explanatory view in a case where a DVD player 50 is operated as an information reproducing system by use of the remote control device 10 of FIG. 1;

FIG. 4 is a flow chart showing an operation of a backlight in the first embodiment of the present invention;

FIG. 5 is a flow chart showing an operation of a backlight in a second embodiment of the present invention;

FIG. 6 is a flow chart showing a detailed operation of vibration detection in a third embodiment of the present invention;

FIG. 7 is a flow chart showing a detailed operation of a sub-routine “vibration detection” in a fourth embodiment of the present invention; and

FIG. 8 is a flow chart showing an operation of a remote control device 10 in the fourth embodiment of the present invention.

### DETAILED DESCRIPTION

Various embodiments according to the invention will be described hereinafter with reference to the accompanying drawings. In general, according to one embodiment of the invention, there is provided a remote control device having a plurality of keys, and having a backlight function of allowing a main body to emit light for a first predetermined time from an operation time in response to an operation of the key and reaction of a vibration sensor, the remote control device including: a control section which performs control to start the first predetermined time every key operation, in a case where the backlight function is started and successively the key is operated.

### (FIRST EMBODIMENT)

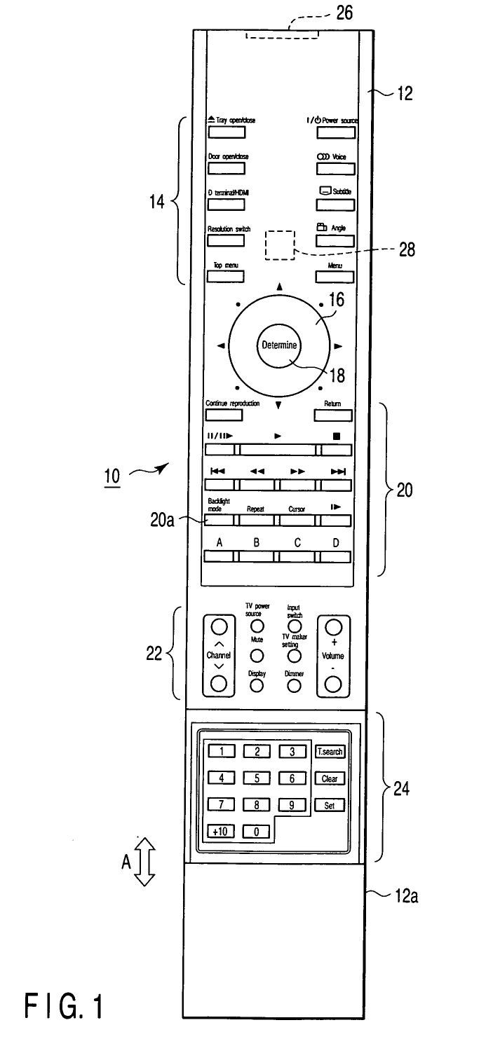

FIG. 1 is a diagram showing an appearance of a remote control device in a first embodiment of the present invention.

This remote control device can control two types of units such as a DVD player and a television.

In FIG. 1, on an operation face of a main body portion 12 of the remote control device 10, there are arranged an operation button group 14, a direction button 16 and a determine button 18, and operation button groups 20, 22 and 24. Moreover, in the front (upper side in FIG. 1) of the remote control device 10, there is disposed a light emitting portion 26 in which an infrared LED and the like are built. When a user depresses a button as each type of key, an infrared signal is transmitted from the light emitting portion 26 to a unit (not shown). Further in the remote control device 10, a known vibration sensor 28 is built to detect a vibration to be applied to the remote control device 10. Furthermore, on a side opposite to the operation face of the remote control device 10, a cell storage section (not shown) is disposed to house a dry cell which drives the remote control device 10.

It is to be noted that this remote control device 10 is constituted to light a backlight, when each type of button is operated by the user (details will be described later). The backlight is constituted to also light, even in a case where the vibration is detected by the vibration sensor 28. This backlight is constituted to automatically turn off with an elapse of a first predetermined time.

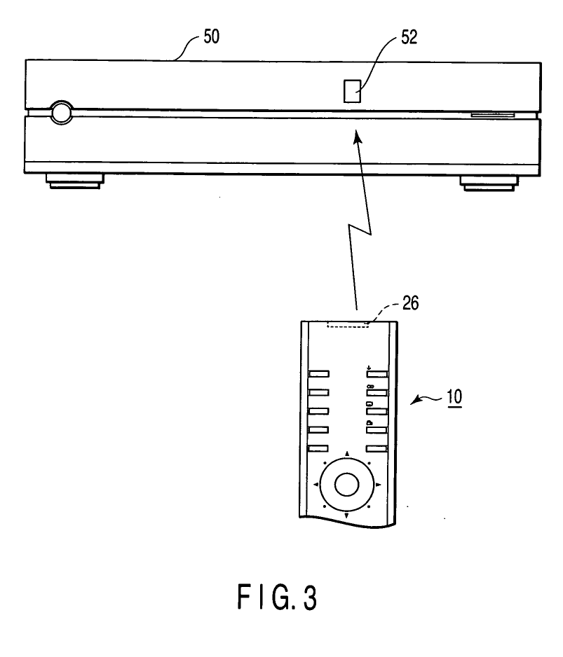

The operation button group 14 relates to a function of setting a DVD player 50 shown in, for example, FIG. 3. When these buttons are depressed by the user, various types of settings of the DVD player 50 are performed.

Moreover, the direction button 16 moves a cursor displayed in a television screen (not shown) in response to the user's operation. The direction button 16 is constituted of four key switches including upper, lower, left and right switches. When these key switches are combined, in the screen the cursor moves in eight directions of obliquely upper right, obliquely lower right, obliquely upper left and obliquely lower left directions in addition to four directions of upper, lower, left and right directions. Moreover, the determine button 18 has a function of indicating item determination. That is, when the user depresses the determine button 18 after operating the direction button 16, there is determined an item in a position where the cursor is displayed in the screen.

The operation button group 20 is constituted of a plurality of buttons concerning an operation of the DVD player. Among them, a backlight mode button 20a lights the buttons of the remote control device 10 for a predetermined time, for example, about ten seconds, in a case where the user depresses the button 20a. The operation button group 22 includes television operating buttons which operate various types of functions of the television. Furthermore, the operation button group 24 includes a number input button and associated buttons. This operation button group 24 is usually covered with a lid 12a which is slidable in a shown arrow A direction so that the operation face of the main body portion 12 is not seen. In a case where the user performs input into the operation button group 24, the user slides the lid 12a to expose the operation button group 24.

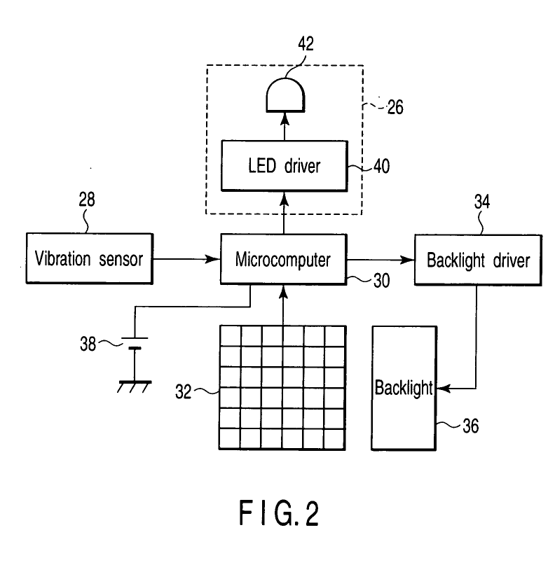

FIG. 2 is a block diagram showing a schematic constitution of this remote control device. It is to be noted that there will be described herein the section associated with the backlight.

In FIG. 2, a microcomputer 30 is a control section which executes a control operation of this remote control device. The microcomputer 30 is connected to: the above light emitting portion 26; the vibration sensor 28; an input section 32 constituted of the above operation button group 14, the direction button 16 and determine button 18 and the operation button groups 20, 22 and 24; a backlight driver 34 for lighting a backlight 36; and a cell (dry cell) 38 as a power source.

The light emitting portion 26 is constituted of a light emitting diode (LED) 42 and an LED driver 40. When any portion of the input section 32 is operated by the user, an instruction signal is output from the microcomputer 30 to the LED driver 40 in response to the operation. The LED driver 40 modulates the instruction signal at a predetermined frequency to supply the signal to the LED 42. Accordingly, the instruction signal is transmitted from the light emitting diode 42 to the unit (not shown).

Moreover, the backlight 36 is disposed on each of backs of the above operation button group 14, the direction button 16 and determine button 18 and the operation button groups 20, 22 and 24, and the backlight is constituted of, for example, an LED. This backlight 36 turns off to prevent power of the cell 38 from being wasted, in a case where the remote control device 10 is not used. Moreover, when the microcomputer 30 judges that the remote control device 10 is used in response to detection of vibration by the vibration sensor 28 or an operation of the input section 32 as described later, the microcomputer 30 lights the backlight 36 for a predetermined time via the backlight driver 34.

FIG. 3 is an explanatory view in a case where a DVD player 50 is operated as an information reproducing system by use of the present remote control device 10.

On a front portion of the DVD player 50 as an information reproducing device, a remote control light receiving portion 52 is disposed to receive a signal from the remote control device 10. Moreover, the user directs the light emitting portion 26 of the remote control device 10 with respect to the remote control light receiving portion 52 of the DVD player 50 with a predetermined distance and a predetermined angle, and presses a desired button among the above operation button groups 14, 20, 22 and 24, the direction button 16 and the determine button 18. Then, a signal corresponding to a function of the pressed button is transmitted from the light emitting portion 26 to the remote control light receiving portion 52. Accordingly, in the DVD player 50, an operation of the function desired by the user is executed.

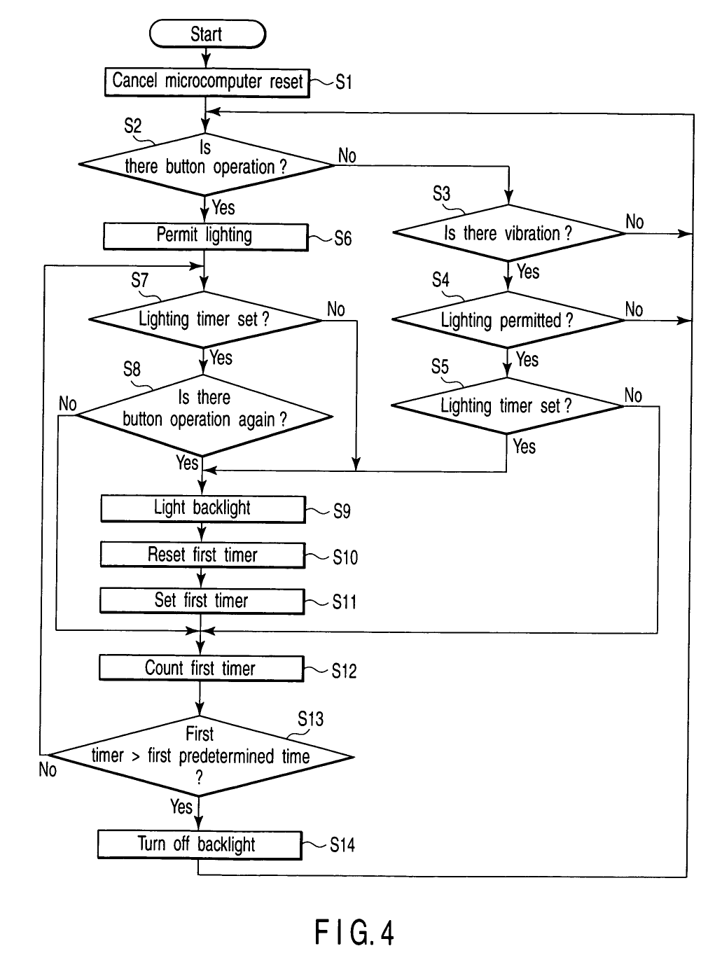

Next, there will be described an operation of the backlight in the present embodiment with reference to a flow chart of FIG. 4. It is to be noted that the operation of this remote control device 10 is performed mainly under the control of the microcomputer 30.

In this remote control device 10, first in step S1, when the cell 38 is charged in the above cell storage section, remote control becomes operable, and reset of the microcomputer 30 is cancelled. Next, in step S2, a state of a button operation is detected. Here, in a case where the button is operated, the flow shifts to step S6. In a case where no button is operated, successively in step S3, a vibration state is detected by the vibration sensor 28.

When no vibration is detected in the step S3, the flow shifts to the step S2. When the vibration is detected, the flow shifts to step S4 to judge whether or not lighting is permitted. Here, in a case where the lighting is not permitted, the flow shifts to the step S2. In a case where the lighting is permitted, the flow shifts to step S5. It is judged in the step S5 whether or not a lighting timer in the microcomputer 30 is set. As a result, when the timer is not set, the flow shifts to step S9 described later. When the timer is set, the flow shift to step S12 described later.

In a case where it is judged in the step S2 that there is the button operation, the flow shifts to the step S6, and there is given “lighting permission” of the backlight 36. Thereafter, it is judged in step S7 whether or not the lighting timer is set. It is judged in this step S7 whether or not the backlight 36 has already been lit.

Since the backlight is not lit in the first button operation, step S8 is skipped, and the backlight is lit in the step S9. Next, the flow shifts to lighting timer processing as a first timer. The lighting timer processing as this first timer means that after the first timer is reset (initialized) in step S10, the timer is set (to be operable) in step S11.

On the other hand, in a case where the lighting timer is set in the step S7, the flow shifts to the step S8 to judge whether or not the button operation has already occurred. Here, in a case where the button operation is performed again, the flow shifts to the step S9. In a case where no button is operated, the flow shifts to the step S12.

In the step S12, the lighting timer processing as the first timer is performed, and processing is performed to regard a time when the button is operated again as a start time. That is, after the first timer is set, the timer is counted. Moreover, it is judged in step S13 whether or not the time counted by the first timer has reached a first predetermined time (e.g., ten seconds).

Here, if the time counted by the timer has not reached the first predetermined time yet, the flow shifts to the step S7 to repeat the subsequent processing operation. Moreover, when the time counted by the first timer reaches the first predetermined time, the flow shifts to step S14 to perform processing to turn off the backlight. Thereafter, the flow shifts to the step S2.

In this manner, according to the first embodiment, when the user operates the button by a series of operations, the backlight 36 emits light for the first predetermined time from the time when the operation is started. When the remote control device 10 is utilized in a dark room, the buttons on the operation face of the device are guided. This gives the user conveniences in confirming a remote control operation or the like. Similarly, in a case where a vibration is applied to the remote control device 10, the backlight 36 lights for the first predetermined time from a time when the vibration starts. This additionally provides the convenience that the backlight lights when the user lifts the remote control device 10.

In the present first embodiment, even in a case where the vibration is detected, when the “lighting permission” is not set, the backlight does not light. This “lighting permission” is constituted to be set when the user operates the button.

In the remote control device to which the present embodiment is not applied, the backlight lights even in response to a vibration before the button operation. Therefore, for example, owing to the vibration in a case where the cell is charged, the backlight lights as soon as the cell is charged, and energy is wastefully consumed. On the other hand, according to the constitution of the present embodiment, the backlight function is stopped from a time when the cell is turned on until the first button operation is performed. Therefore, the backlight is prevented from being lit in response to the user's button operation at a time when the cell is charged and in a case different from a purpose of lifting the device, and the useless power consumption can be prevented.

It is to be noted that as to the above first predetermined time, in an only case where the user operates the button, the start time may be set upon every operation time. In consequence, the user does not have to operate all within the predetermined time. Moreover, even in a case where the remote control device 10 is laid in a vibrating place, it is possible to prevent the useless power consumption due to continuous lighting of the backlight 36.

### (SECOND EMBODIMENT)

Next, a second embodiment of the present invention will be described.

In the above first embodiment, a backlight is lit for a predetermined time from a time when a user operates a button. Moreover, the backlight is lit with an elapse of a predetermined time after a vibration is applied to a remote control device. In this second embodiment, a start time is set by a user's button operation for a predetermined time and every operation time.

It is to be noted that a constitution and a basic operation of the remote control device in the second embodiment are the same as those of the remote control device of the first embodiment shown in FIGS. 1 to 4. Therefore, the same parts are denoted with the same reference numerals, drawings and descriptions thereof are omitted, and an only different parts will be described.

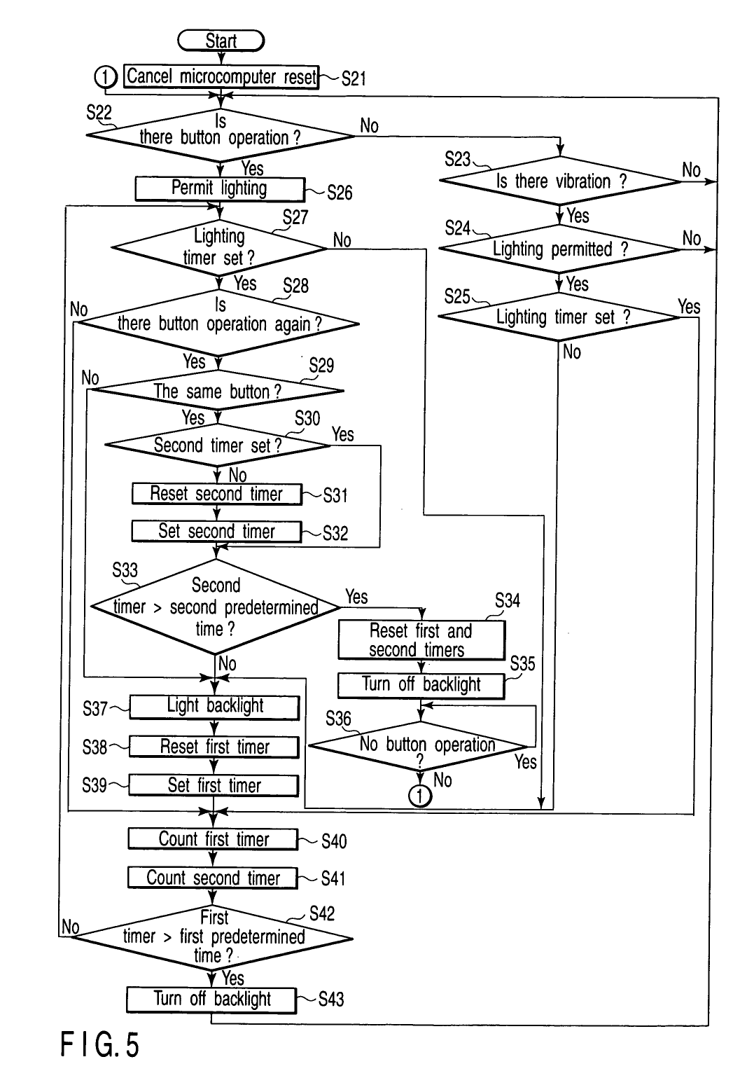

There will be described hereinafter an operation of the remote control device in the second embodiment of the present invention with reference to the flow chart of FIG. 5. It is to be noted that the operation of this remote control device 10 is performed mainly under control of a microcomputer 30.

FIG. 5 is a flow chart showing the basic operation of the remote control device 10 in the second embodiment. It is to be noted that in the flow chart of FIG. 5, since processing operations of steps S21 to S28, S37 to S40 and S42 and S43 are the same as those of the step S1 to S8, S9 to S12 and S13 and S14 of the above flow chart of FIG. 4, the corresponding step numbers are referred to, and description thereof herein is omitted.

In the step S28, it is detected whether or not the button is operated again. As a result, in a case where the button is not operated again, the flow shifts to the step S40. In a case where the button is operated again, the flow shifts to step S29. In the step S29, it is judged whether or not the same button is operated. Here, in a case where the same button is not operated, the flow shifts to the step S37. In a case where the same button is operated, the flow shifts to step S30.

In the step S30, in the microcomputer 30, there is detected a state of a second timer which is different from the lighting timer (first timer) judged in the step S27. Here, when the second timer is set, a processing operation of steps S31 and S32 described later is skipped. On the other hand, when the second timer is not set, the flow shifts to the step S31. That is, the flow shifts to lighting timer processing as the second timer. This lighting timer processing as this second timer means that after the second timer is reset (initialized) in the step S31, the timer is set (to be operable) in the step S32.

When the second timer is set in the step S32, in the subsequent step S33, it is judged in the same routine as that of the above first timer whether or not a time counted by the second timer has reached a second predetermined time (e.g., 30 seconds). Here, when the time does not reach the second timer time, the flow shifts to the step S37. When the time is reached, the flow shifts to step S34.

In the step S34, both of the above first and second timers are reset. Moreover, after the backlight 36 is turned off in step S35, the presence of the button operation is detected in step S36. Here, the backlight 36 is not lit until the button operation is cancelled. Moreover, when the button is operated, the flow shifts to the step S22 to repeat the subsequent processing operation.

After the backlight is lit, and the processing operation of the first timer is performed in the steps S37 to S40, in step S41, the lighting timer processing as the second timer is performed, and processing is performed to regard a time when the button is operated again as the start time. That is, after the second timer is set, the timer is counted. Thereafter, the flow shifts to the step S42.

In this manner, according to the second embodiment, for example, even when the remote control device 10 is laid on a table with an operation face thereof turned downwards, and the operation by the operation button is generated regardless of user's intention, the backlight turns off after elapse of the second predetermined time, and it is therefore possible to prevent useless power consumption.

### (THIRD EMBODIMENT)

Next, a third embodiment of the present invention will be described.

In the present third embodiment, a vibration sensor is read to judge the presence of sensor reaction. In a case where there is the reaction of the sensor, the presence of lighting of a backlight at this time is judged.

It is to be noted that a constitution and a basic operation of the remote control device in the third embodiment are the same as those of the remote control devices of the first and second embodiments shown in FIGS. 1 to 5. Therefore, the same parts are denoted with the same reference numerals, drawings and descriptions thereof are omitted, and an only different parts will be described.

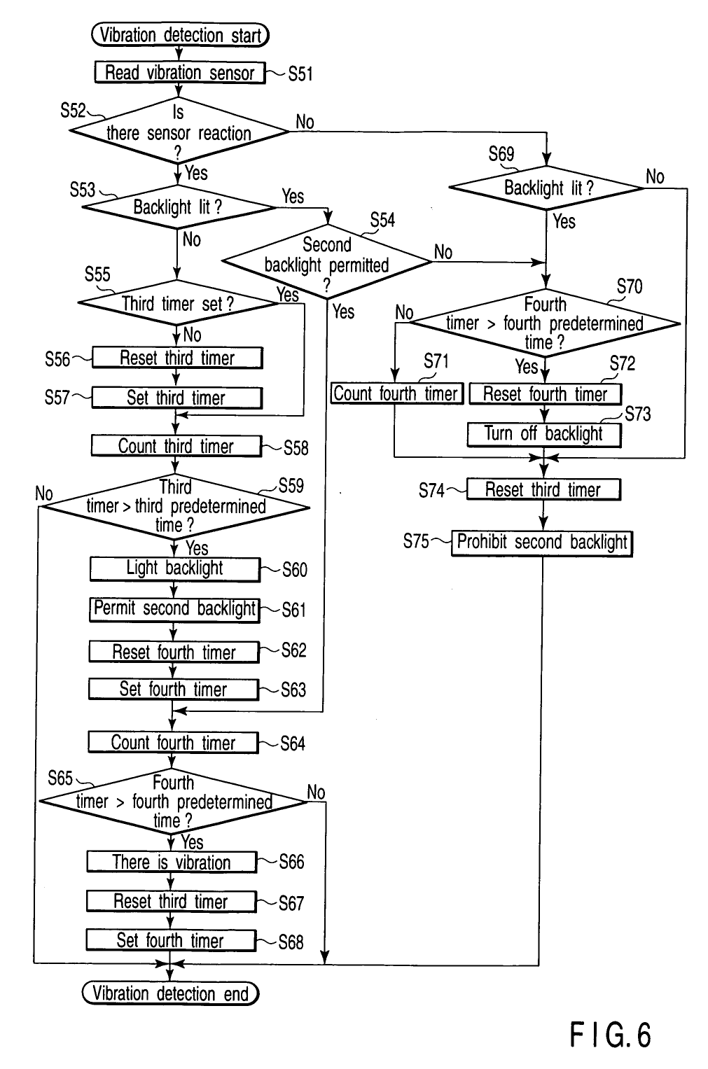

The third embodiment of the present invention will be described hereinafter with reference to a flow chart of FIG. 6.

FIG. 6 is the flow chart showing a detailed operation of vibration detection.

When the present routine is started, first in step S51, a vibration sensor 28 is read. Next, in step S52, it is judged whether or not there is reaction of the vibration sensor 28. Here, in a case where there is no reaction of the sensor, the flow shifts to step S69 described later. On the other hand, in a case where there is a sensor reaction, the flow shifts to step S53, and it is judged whether or not a backlight 36 lights at this time.

In a case where the backlight 36 does not light in the step S53, the flow shifts to step S55, and it is judged whether or not a third timer different from the first and second timers is set in a microcomputer 30. In a case where the third timer is not set, in the subsequent step S56, the third timer is reset (initialized), and the timer is set (to be operable) further in step S57. Accordingly, in a case where there is a reaction of the vibration sensor 28, and the backlight 36 is turned off at this time, the third timer can count. Therefore, in step S58, the counting of the third timer is started. It is to be noted that in a case where the third timer is set in the step S55, the above steps S56 and S57 are skipped.

Next, it is judged in step S59 whether or not a time counted by the third timer is above a third predetermined time (e.g., 0.7 second). Here, in a case where the third predetermined time does not elapse, the vibration has not been verified yet after start of the reaction of the vibration sensor 28. Therefore, in this state, a vibration detecting routine ends. On the other hand, in a case where the third predetermined time elapses, the flow shifts to step S60, and at this time, the backlight 36 is lit as a first backlight. Successively, in step S61, “second backlight permission” is set to reach full backlight lighting.

Thereafter, to detect the full backlight lighting, in step S62, a fourth timer different from the first to third timers is reset (initialized) in the microcomputer 30, and next in step S63, the fourth timer is set (to be operable). Accordingly, in a case where the first backlight is lit, and there is successively a reaction of the vibration sensor, the fourth timer can count, and in step S64 the fourth timer is started.

Moreover, it is judged in step S65 whether or not a time counted by the fourth timer is above a fourth predetermined time (e.g., 0.7 second). Here, in a case where the fourth predetermined time has not elapsed, the first backlight is lit, and there is a state in which the vibration has not been verified yet. Therefore, in this state, the vibration detecting routine ends. On the other hand, in a case where the fourth predetermined time has elapsed in the step S65, the flow shifts to step S66. At this time, “the presence of the vibration” is set to reach the full backlight lighting.

It is to be noted that in a case where the backlight 36 is lit in the step S53, the flow shifts to step S54, and the presence of “second backlight permission” is judged. Here, when the “second backlight permission” is further set, the counting of the third timer is discontinued, because the backlight 36 is lit. Moreover, the flow shifts to the step S64, and the counting of the fourth timer is performed.

In addition, in the above step S65, in a case where there is no reaction of the vibration sensor 28 even once before the fourth timer reaches the fourth predetermined time, the flow shifts to the step S69 to transfer to a loop in which the “second backlight” is prohibited. In this loop, the fourth timer counts time up to the fourth predetermined time. After the fourth predetermined time is reached, the backlight turns off.

That is, it is judged in the step S69 whether or not the backlight 36 is lit. Here, when the backlight is not lit, the flow shifts to step S74. When the backlight is lit, the flow shifts to step S70, and it is judged whether or not a time counted by the fourth timer is above the fourth predetermined time. As a result, in a case where the fourth predetermined time has not elapsed, the flow shifts to step S71, and the fourth timer performs counting. On the other hand, in a case where the fourth predetermined time has elapsed in the step S70, the flow shifts to step S72, and the fourth timer is reset.

Thereafter, when in step S73 the backlight 36 is turned off, and in the subsequent step S74 the third timer is reset, in step S75 the second backlight is prohibited. Thereafter, the present routine ends.

In this manner, when the vibration sensor 28 reacts without reaching the third predetermined time, the backlight 36 does not light. When the vibration sensor 28 continues the reaction for the fourth predetermined time in addition to the third predetermined time, the original lighting of the backlight 36 is permitted. When the reaction continues until the third predetermined time but the vibration sensor 28 does not react before reaching the fourth predetermined time, the backlight 36 emits light for the fourth predetermined time.

According to the present third embodiment, i) if there is a vibration generated by laying another object on the table or the like where a remote control device 10 has been laid, and the vibration is generated before reaching the third predetermined time, the backlight 36 does not light. That is, the backlight lighting in response to minor vibration is prevented, and useless power consumption can be prevented. Moreover, ii) in a case where the user grasps the remote control device 10, and visually confirms the remote control device 10, even when the time does not elapse as much as or above a combined time of the third and fourth predetermined times from the start of the grasping, the backlight 36 lights as long as the third predetermined time elapses. Therefore, it is possible to visually confirm the device even in a dark room.

Furthermore, iii) in a case where the user slightly moves the remote control device, and the time does not elapse as much as or above the combined time of the third and fourth predetermined times from the start of the moving, when there is a vibration, the backlight 36 is lit for the fourth predetermined time. Therefore, useless power consumption can be prevented.

That is, according to the third embodiment, the remote control device is constituted to have a three-stage lighting mode including the above i) to iii).

### (FOURTH EMBODIMENT)

Next, a fourth embodiment of the present invention will be described.

This fourth embodiment is different from the above third embodiment in that in a case where a third predetermined time or more elapses from start of a vibration sensor, and a time obtained by combining the third predetermined time and a fourth predetermined time does not elapse, when there is a vibration, “short lighting count” is performed.

It is to be noted that a constitution and a basic operation of the remote control device in the fourth embodiment are the same as those of the remote control device of the first to third embodiments shown in FIGS. 1 to 6. Therefore, the same parts are denoted with the same reference numerals, drawings and descriptions thereof are omitted, and only different parts will be described.

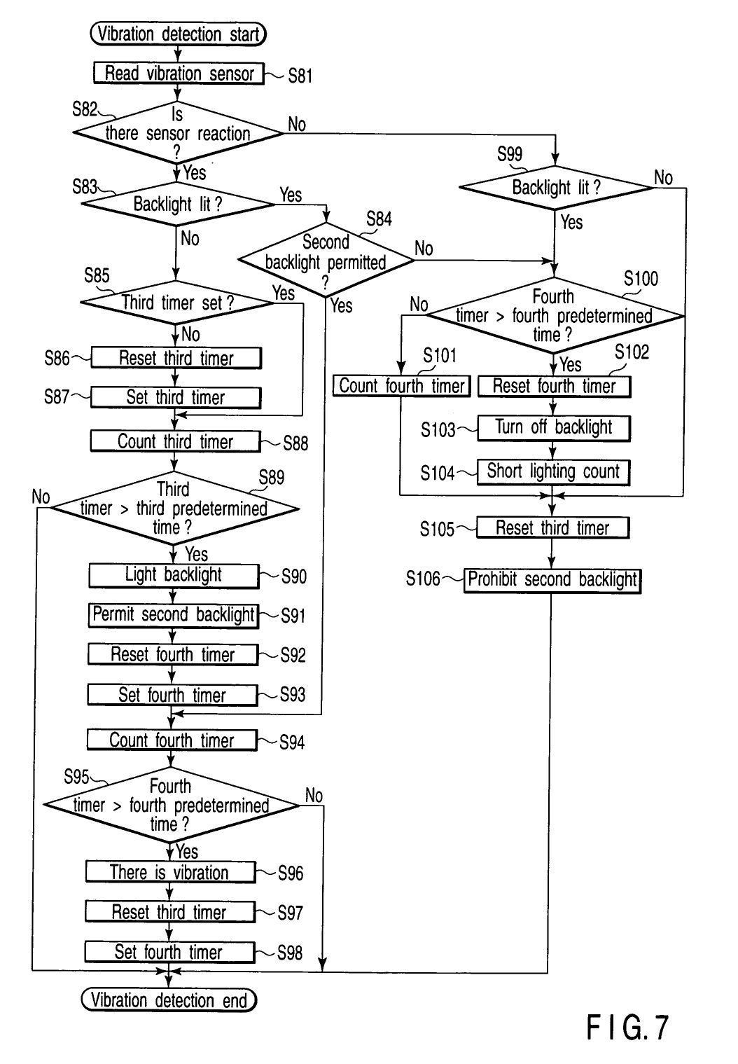

The fourth embodiment of the present invention will be described hereinafter with reference to a flow chart of FIG. 7.

FIG. 7 is the flow chart showing a detailed operation of a sub-routine “vibration detection”. It is to be noted that in the flow chart of FIG. 7, processing operations of steps S81 to S104 and S105 and S106 are the same as those of the steps S51 to S73 and S74 and S75 of the above flow chart of FIG. 6. Therefore, the corresponding step numbers are referred to, and description thereof herein is omitted.

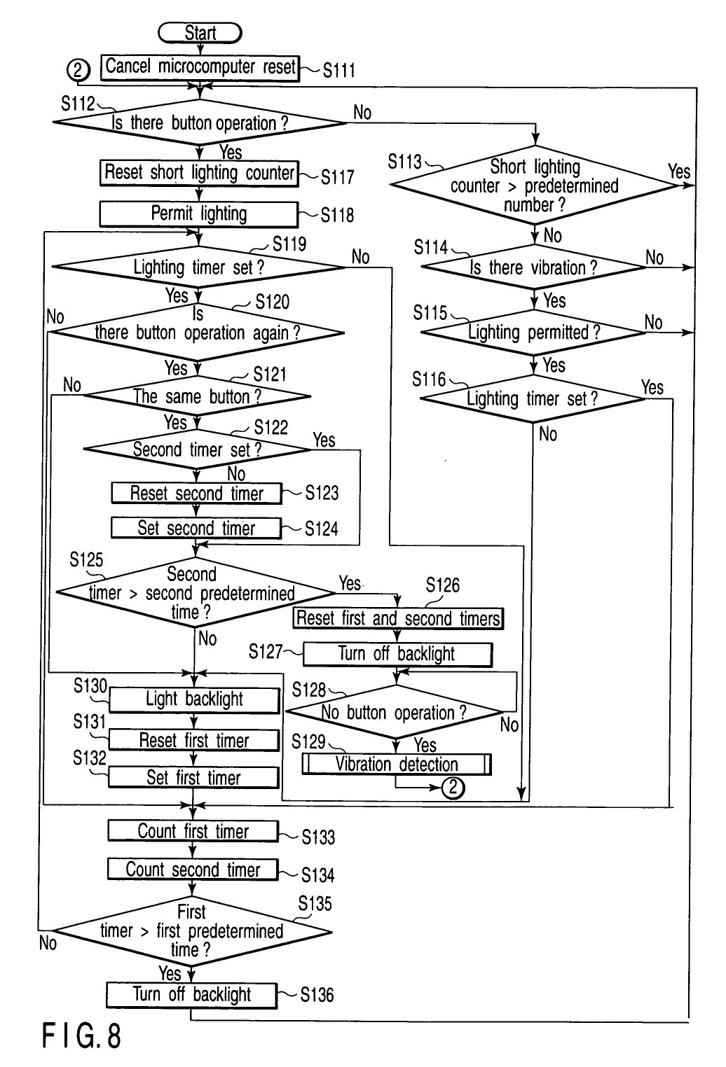

When a backlight 36 is turned off in the step S103, in the step S104, the short lighting count is started. That is, in a case where the third predetermined time or more elapses from the start of the vibration detection of a vibration sensor 28, and the time obtained by combining the third and fourth predetermined times does not elapse, when there is a vibration, this “short lighting count” is performed. This counted number is judged in a routine in a case where there is no button operation in step S128 in a flow chart of FIG. 8. If the number is not less than the predetermined number of times, the flow does not shift to the backlight lighting due to the vibration. This count is reset (initialized) only in a case where there is a key operation.

An operation of a remote control device 10 in the fourth embodiment will be described with reference to the flow chart of FIG. 8. It is to be noted that in the flow chart of FIG. 8, processing operations of steps S111 and S112, S114 to S116, S118 to S128 and S130 to S136 are the same as those of the steps S21 and S22, S23 to S25, S26 to S36 and S37 to S43 of the above flow chart of FIG. 5. Therefore, the corresponding step numbers are referred to, and description thereof herein is omitted.

In the step S128, in a case where there is no button operation, the short lighting count is performed as described above in the sub-routine “vibration detection” of step S129. Moreover, the flow shifts to the step S112. Since there is no button operation, the flow shifts to step S113. In this step S113, it is judged whether or not the number counted by the short lighting counter is not less than the predetermined number of times. Here, when the number is not less than the predetermined number of times, the flow does not shift to the backlight lighting (step S130) due to the vibration, and the flow shifts to the step S133.

Moreover, the counting of this short lighting counter is reset (initialized) only in step S117 after it is judged in the step S112 that there is a button operation.

In this manner, according to the fourth embodiment, in a case where a minor vibration is repeatedly generated, for example, in a case where the remote control device 10 is laid on a table while a sound volume is large or a case where the device still having a cell 38 charged therein is transported, the lighting for a fourth predetermined time is also prohibited. Therefore, useless power consumption can be prevented.

The embodiments of the present invention have been described above, but besides the above embodiments, the present invention can variously be modified and implemented without departing from the scope of the present invention.

Furthermore, the above embodiments include various stages of inventions, and various inventions can be extracted by an appropriate combination of a plurality of disclosed constituting requirements. For example, even if several constituting requirements are deleted from all of the constituting requirements described in the embodiments, it is possible to solve the problems described in paragraphs of the problem to be solved by the invention, and effects described in paragraphs of the effect of the invention are obtained. In this case, even a constitution obtained by deleting the constituting requirements can be extracted as the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A remote control device having a plurality of keys, and having a backlight function of allowing a main body to emit light for a first predetermined time from an operation time in response to an operation of the key and reaction of a vibration sensor,
the remote control device comprising:
a control section which performs control to start the first predetermined time every key operation, in a case where the backlight function is started and the key is successively operated.

2. The remote control device according to claim 1, wherein the control section performs the control to stop the backlight function from a time when a cell is turned on until a first key of the plurality of keys is operated.

3. The remote control device according to claim 1, wherein the control section performs the control to stop the backlight function in a case where the operation of the same key among the plurality of keys continues for a second predetermined time.

4. The remote control device according to claim 1, wherein the control section performs the control to light the backlight only for a fourth predetermined time in a case where the vibration sensor reacts in a third predetermined time, and to further light the backlight for the first predetermined time in a case where the vibration sensor reacts in the fourth predetermined time after the fourth predetermined time.

5. A remote control device comprising:
a cell as a power source;
a plurality of keys corresponding to a plurality of functions;
a vibrating section which detects vibration applied to the device;
a lighting section which lights and displays the plurality of keys; and
a control section which performs control to light the lighting section for a first predetermined time from a start time of at least one of a case where any of the plurality of keys is operated and a case where the vibration is detected by the vibrating section,
wherein the control section perform the control to stop lighting of the lighting section from a time when the cell is charged until a first key operation is performed.

6. The remote control device according to claim 5, wherein the control section performs the control to repeatedly light the lighting section for the first predetermined time every key operation, in a case where any of the plurality of keys is operated for the first predetermined time for which the lighting section is lit.

7. The remote control device according to claim 6, wherein the control section stops the lighting of the lighting section, in a case where the operation of the same key among the plurality of keys continues for a second predetermined time.

8. The remote control device according to claim 6, wherein the control section performs the control to light the lighting section only for a fourth predetermined time in a case where the vibrating section reacts in a third predetermined time, and to further perform the control to light the lighting section for the first predetermined time, in a case where the vibrating section reacts in the fourth predetermined time after the fourth predetermined time.

9. The remote control device according to claim 8, wherein the control section performs the control to stop the lighting of the lighting section until the key is operated, in a case where the vibrating section continues the reaction only for the third predetermined time.

10. An information reproducing system comprising:
a remote control device having a plurality of keys, having a backlight function of allowing a main body to emit light for a first predetermined time from an operation time in response to an operation of the key and reaction of a vibration sensor, and performing control to stop the backlight function from a time when a cell is turned on until a first key of the plurality of keys is operated; and
an information reproducing device which receives data of the remote control device and which performs processing in accordance with the data.
